(19) United States
(12) Patent Application Publication
(10) Pub. No.: US 2008/0172408 A1
(43) Pub. Date: Jul. 17, 2008

(54) Converting Recursive Hierarchical Data to Relational Data

(75) Inventors: Dikran S. Meliksetian, Danbury, CT (US); George A. Mihaila, Yorktown Heights, NY (US); Sriram K. Padmanabhan, San Jose, CA (US); Nianjun Zhou, Somers, NY (US)

Correspondence Address: FREDERICK W. GIBB, III;Gibb & Rahman, LLC, 2568-A RIVA ROAD, SUITE 304, ANNAPOLIS, MD, 21401, US

(73) Assignee: International Business Machines Corporation, Armonk, NY (US)

(21) Appl. No.: 12/055,009

(22) Filed: Mar. 25, 2008

Related U.S. Application Data
(63) Continuation of application No. 11/303,432, filed on Dec. 16, 2005.

(51) Int. Cl. G06F 17/30

(52) U.S. Cl. 707/102; 707/E17.044

(57) ABSTRACT

A system and method of converting a recursive XML document into a relational schema comprises providing a recursive XML document; parsing an external mapping script specifying a mapping from the recursive XML document to a relational table format; building a recursive shredding tree based on the external mapping script and the relational table format; and shredding the mapped recursive XML document into a relational table. The system and method further comprise detecting whether any of a XML schema and a DTD document is recursive, wherein the detecting comprises building a directed graph comprising element names; corresponding elements names as nodes in the directed graph; forming arcs from every element parent node to every element child node of the element parent node; and checking for cycles in the directed graph. The system and method further comprise identifying all recursive cursor nodes and a recursive degree corresponding to the recursive shredding tree.

### CROSS-REFERENCE TO RELATED APPLICATIONS

This application is a Continuation of U.S. application Ser. No. 11/303,432 filed Dec. 16, 2005, the complete disclosure of which, in its entirety, is herein incorporated by reference.

### BACKGROUND

1. Field of the Invention

The embodiments herein generally relate to data storage and conversion, and, more particularly, to data management and transformation for storing documents into relational databases.

2. Description of the Related Art

In the information technology (IT) industry, the manner in which to efficiently store eXtensible Markup Language (XML) data into a persistent repository, such as a relational database, is a major technical problem. The reason is that XML is widely used and emerging as the de facto standard format of message exchange between applications running on different computer systems. An XML schema or Document Type Definition (DTD) is called recursive if it allows an element to contain another element with the same name as a descendent element. The possible sequence of these recursive elements can be represented by an expression in an XPath format, hereinafter referred to as a “recursive XPath.” A recursive XML schema or DTD should preferably have at least one recursive XPath. Hereinafter, an XML document abiding to a recursive XML schema or DTD is called “recursive XML document.”

There are many business applications that require the use of recursive XML, such as applications in the life sciences, the insurance industry, and manufacturing. In fact, any information object represented in XML which contains at least one child (or descendant) element with the same features as itself should be defined as recursive. For example, a part can contain another part as a sub-part, which itself can contain a sub-part. Therefore, the part information should be described using recursive XML.

A unique feature of recursive XML is that a portion of the document can have the same structure as the whole document. Moreover, the depth of a recursive XML is not pre-determined due to the above feature. For a recursive XML schema/DTD structure, an XML document instance abiding to the structure could have arbitrarily many levels of recursion. The level of recursion is defined herein as the number of occurrences of the same XML element name in a path from a root node to a leaf node. In practice, documents usually only have a limited number of levels of recursion. Notwithstanding advances in the industry, there remains a need for a new technique of converting hierarchical data to relational data.

### SUMMARY

In view of the foregoing, the embodiments herein provide a method of converting a recursive XML document into a relational schema, and a program storage device readable by computer, tangibly embodying a program of instructions executable by the computer to perform a method of converting a recursive XML document into a relational schema, wherein the method comprises providing a recursive XML document; parsing an external mapping script specifying a mapping from the recursive XML document to a relational table format; building a recursive shredding tree based on the external mapping script and the relational table format; and shredding the mapped recursive XML document into a relational table. The method may further comprise detecting whether any of a XML schema and a DTD document is recursive, wherein the detecting comprises building a directed graph comprising element names; corresponding elements names as nodes in the directed graph; forming arcs from every element parent node to every element child node of the element parent node; and checking for cycles in the directed graph.

The method may further comprise identifying all recursive cursor nodes and a recursive degree corresponding to the recursive shredding tree. Additionally, the method may further comprise mapping recursive elements of the recursive XML document to shredding tree nodes of the recursive shredding tree. Preferably, the recursive shredding tree comprises a working area hashtable. Moreover, the method may further comprise storing all XPaths of the recursive shredding tree in a global lookup table; performing a depth-first tree traversal of the recursive shredding tree; computing a current XPath for each node in the recursive XML document; comparing the XPath to each of the stored XPaths in the global lookup table; and determining, for all matched XPaths, a corresponding set of arrays comprising tuples of shredded data in the recursive shredding tree.

Another embodiment provides a system of converting a recursive XML document into a relational schema, wherein the system comprises a recursive XML document; a parser adapted to parse an external mapping script specifying a mapping from the recursive XML document to a relational table format; a recursive shredding tree formatted based on the external mapping script and the relational table format; and a relational table comprising the mapped recursive XML document. The system may further comprise a first mechanism adapted to detect whether any of a XML schema and a DTD document is recursive by building a directed graph comprising element names; corresponding elements names as nodes in the directed graph; forming arcs from every element parent node to every element child node of the element parent node; and checking for cycles in the directed graph.

Preferably, the parser is adapted to identify all recursive cursor nodes and a recursive degree corresponding to the recursive shredding tree. Also, the system may further comprise a mapping mechanism adapted to map recursive elements of the recursive XML document to shredding tree nodes of the recursive shredding tree. Preferably, the mapping mechanism comprises a global lookup table. Furthermore, the recursive shredding tree preferably comprises a working area hashtable. The system may further comprise a runtime methodology module adapted to store all XPaths of the recursive shredding tree in a global lookup table; perform a depth-first tree traversal of the recursive shredding tree; compute a current XPath for each node in the recursive XML document; compare the XPath to each of the stored XPaths in the global lookup table; and determine, for all matched XPaths, a corresponding set of arrays comprising tuples of shredded data in the recursive shredding tree. Moreover, the system may further comprise a second mechanism adapted to invoke multiple non-recursive shredding processes based on a content of the mapped recursive XML document.

These and other aspects of the embodiments herein will be better appreciated and understood when considered in conjunction with the following description and the accompanying drawings. It should be understood, however, that the following descriptions, while indicating preferred embodiments herein and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 illustrates an example of a recursive DTD according to an embodiment herein;

FIG. 2 illustrates an example of a recursive XML document instance abiding by the DTD provided in FIG. 1 according to an embodiment herein;

FIG. 3 illustrates a tree representation of the XML document provided in FIG. 2 according to an embodiment herein;

FIG. 4 illustrates a recursive shredding tree defining a mapping from the recursive XML structure defined by the DTD in FIG. 1 according to an embodiment herein;

FIG. 5 illustrates the result of shredding the recursive document instance from FIG. 2 using the mapping defined by the shredding tree provided in FIG. 4 according to an embodiment herein;

FIGS. 6(A) through 6(C) illustrate schematic diagrams of work area arrays according to an embodiment herein;

FIG. 7 illustrates a schematic diagram of a system according to an embodiment herein;

FIG. 8 illustrates a computer system diagram according to an embodiment herein; and

FIG. 9 is a flow diagram illustrating a preferred method of an embodiment herein.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. It should be noted that the features illustrated in the drawings are not necessarily drawn to scale. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

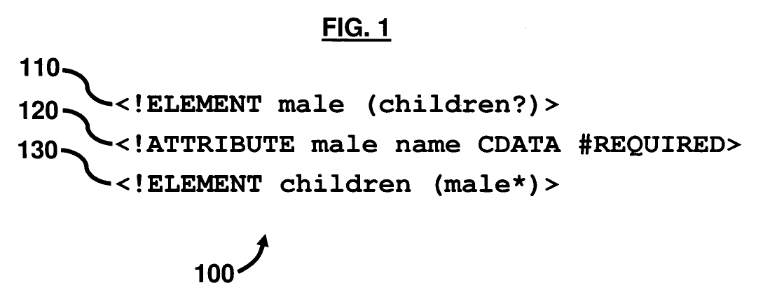

As mentioned, there remains a need for a new technique of converting hierarchical data to relational data. The embodiments herein achieve this by providing a method of shredding specific types of XML documents, recursive XML documents. Referring now to the drawings, and more particularly to FIGS. 1 through 9, where similar reference characters denote corresponding features consistently throughout the figures, there are shown preferred embodiments.

Hereinafter the term “hierarchical data” refers to data arranged in a hierarchical format, whereby elements, or nodes, of the data structure are organized in a descending or ascending hierarchy. A hierarchical data structure is typically illustrated using a descending tree structure. The term “relational data” refers to data arranged in a relational format, whereby elements of the data structure are arranged in rows having one of more columns. A relational data structure is typically illustrated using a table structure. The term “mapping” refers to a system for translating data from one data structure to another data structure. A mapping can be a one-to-one mapping, a many-to-one mapping, a one-to-many mapping or a many-to-many mapping. The term “shredding tree” refers to a data structure used to represent a mapping for translating data from a hierarchical data structure to a relational data structure. The term “schema” refers to a hierarchical structure used for defining relationships between elements, or nodes, of the data structure of the hierarchical data structure and a specific table from the relational structure, and wherein no instance data is present in the schema tree. The term “instance” refers to a hierarchical data abiding to a hierarchical data structure. The instance tree can be viewed as instance of the hierarchical data structure.

The embodiments herein provide a technique to convert a recursive XML shredding process to multiple non-recursive XML shredding processes and extend the process described in U.S. Patent Application No. 2004/0220954, the complete disclosure of which, in its entirety, is herein incorporated by reference. The following example is used describe the embodiments. A recursive XML schema defining a family tree includes an element specified using the recursive XPath //children/male. This XPath can be used to specify multiple chains of father-son relationships. Also, the generation number of the father-son relationship is unknown in general. However, for a given family tree, there are only a limited number of generations. Suppose that it is desired to shred these XML documents describing family trees into a relational database management system (RDBMS) database with a table (for example, father_son) with column names given as “father” and “son”. For a family with five generations of father-son relationships, a male's name could appear both in the ‘father’ column and ‘son’ column. A depth-first tree traversal is performed for the XML document when shredding the document. The shredding marks a male either as a father or a son at a given moment but not both, which is accomplished by creating five shredding processes. Accordingly, at each process, a male member can only appear either as ‘father’ or as ‘son’.

FIG. 1 provides an example of a recursive DTD 100. Here, line 110 specifies that a “male” element can have zero or one sub-element “children”; line 120 specifies that a “male” element has a mandatory attribute “name”; and line 130 specifies that a “children” element can have zero or more “male” sub-elements. This means that a “male” element can appear as a descendent of another “male” element, which effectively makes the DTD 100 recursive.

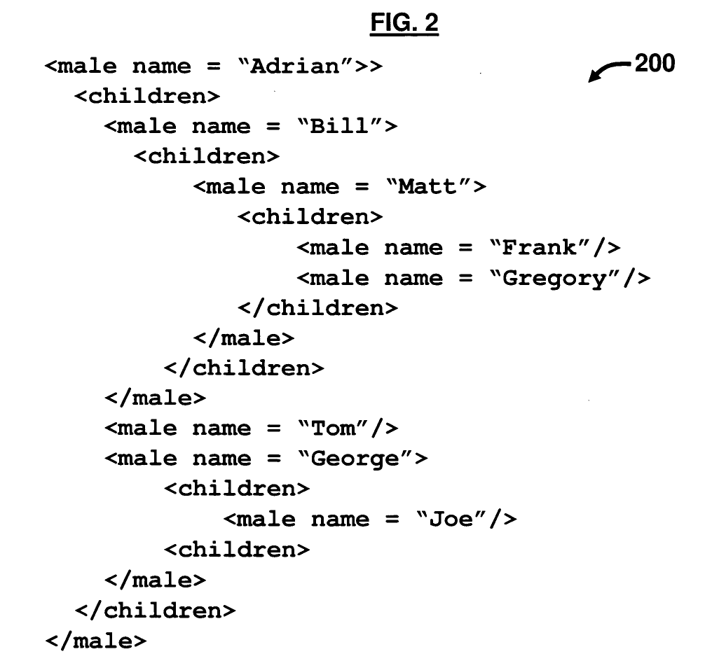

FIG. 2 provides an example of a recursive XML document 200 abiding by the DTD 100 given in FIG. 1. The XML document 200 shown in FIG. 2 includes information about the male descendants of a single person named Adrian. Thus, the first “male” element has a “name” attribute with the value “Adrian”. This element has a single sub-element “children” which in turn comprises three other “male” elements: the first one whose “name” attribute has the value “Bill”, the second one whose “name” attribute has the value “Tom” and the third one whose “name” attribute has the value “George”. The element representing Bill has a “children” sub-element with two other “male” sub-elements, one for Frank and one for Gregory. The element corresponding to Bill has no sub-elements, which signifies the fact that Bill has no male children. Finally, the element corresponding to “George” has a sole “children” sub-element which in turn includes a single “male” sub-element, corresponding to George's son Joe.

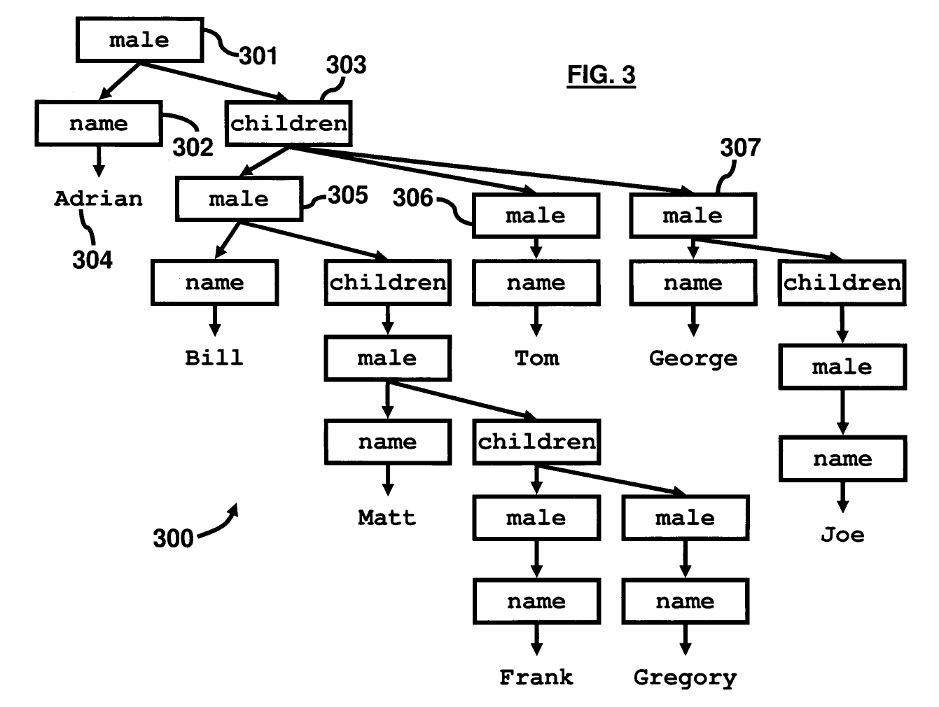

FIG. 3 shows a tree representation 300 of the XML document 200 given in FIG. 2. This tree representation 300 of the XML document 200 has nodes for each element and attribute of the file and leaf nodes for the text values. The element—sub-element containment relationship from the XML document 200 is represented by a parent-child link in the tree 300. The element—attribute containment relationship is also represented by a parent-child link in the tree 300. Thus, the tree 300 has a root node 301 labeled “male” with a child node 302 labeled “name” and another child node 303 labeled “children”. The “name” node 302 has a text child node 304 with value “Adrian”, corresponding to the value of the “name” attribute in the XML document 200. The “children” node 303 has three child nodes, 305, 306, 307 all labeled “male”, one for each of the male children of Adrian. The remaining nodes of the tree 200 represent Adrian's grandchildren and great-grandchildren, shown in a structure similar to a family tree.

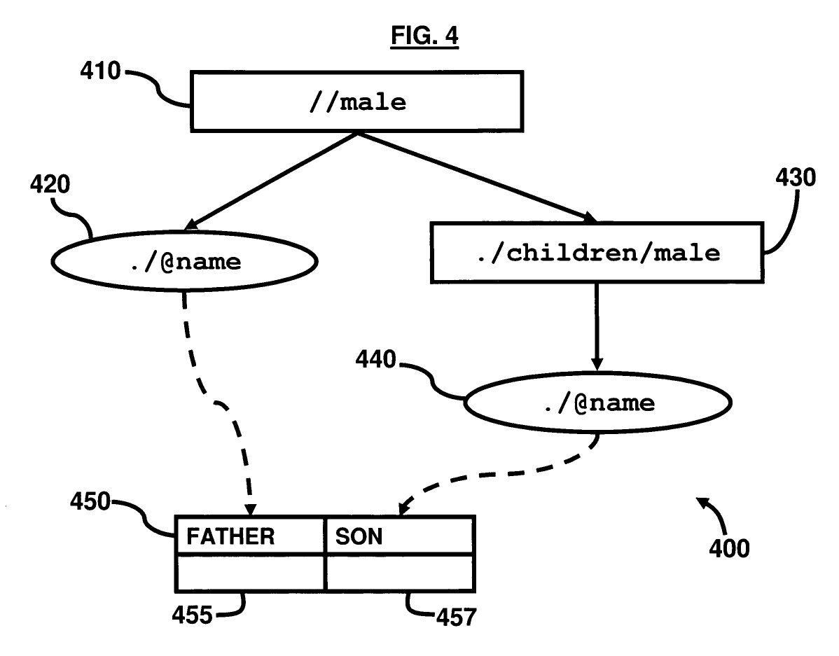

FIG. 4 depicts a recursive shredding tree defining a mapping 400 from the recursive XML structure 200 defined by the DTD 100 in FIG. 1 to a relational table 450. Here, the node 410 is a recursive cursor node labeled with the recursive XPath expression “/male”. The “1” notation at the beginning of the XPath expression refers to any descendent of the root element so this XPath expression matches any “male” element that is a descendent of the root of the document. The node 420 is a data node labeled with the relative XPath expression “./@name” which matches the “name” attribute of the current element (as matched by the parent cursor node 410). The node 420 is bound to the “FATHER” column 455 of the relational table 450, which means that the values matched by this data node 420 will be stored in that column 455. The node 430 is another cursor node, labeled with the relative XPath expression “./children/male” which matches all of the “male” sub-elements of the “children” sub-element of the current node (as matched by the parent cursor node 410). The node 440 is a data node labeled by the relative XPath expression “./@name” which matches the “name” attribute of the current element (as matched by the parent cursor node 430). The node 440 is bound to the “SON” column 457 of the relational table 450, which means that the values matched by this data node 440 will be stored in that column 457.

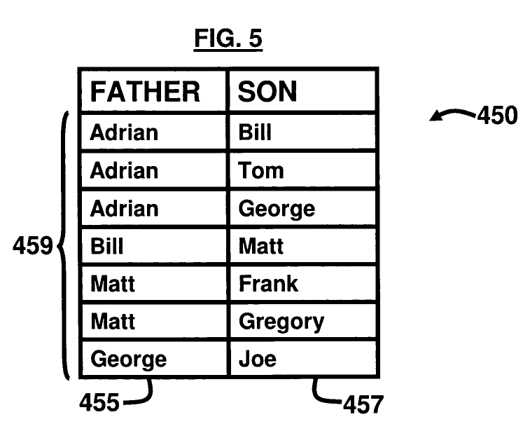

FIG. 5 depicts the result of the shredding of the recursive document instance 200 from FIG. 2 using the mapping 400 defined by the shredding tree given in FIG. 4. Thus, for every “male” sub-element s of a “children” sub-element of another “male” element f, a row 459 including the value of the “name” attribute off in the FATHER column 455 and the value of the “name” attribute of s in the SON column 457 was inserted into the table 450.

As mentioned, an XML schema or DTD 100 is called recursive if it allows an element to contain another element with the same name as a descendent. An XML document instance 200 abiding to the XML schema or DTD 100 is therefore called a recursive XML document. The embodiments herein provide a presentation of the possible sequences of these recursive elements in an instance 200 of the recursive XML document 100 in an XPath format. A recursive shredding tree 300 defines the mapping 400 from the XML schema 100 to a table 450. The relationship is defined by a set of pairs of the XPath and the column number 455, 457. Two kinds of the nodes defined for the shredding tree 300 are (1) the cursor node 410, 430 corresponding to an element XPath (which could be a recursive XPath); and (2) the data node 420, 440 specifying a data value corresponding to an XPath to XML attribute value or XML text node value.

Preferably, there are three types of cursor nodes 410 or 430 for the recursive shredding tree 300. The cursor nodes 410, 430 are totally ordered, in the sense that all cursor nodes are on the same path from the root node 301. The three types of cursor nodes are: (1) a normal cursor node, which are cursor nodes before the first recursive cursor node; (2) a recursive cursor node, which is specified by a recursive XPath; and (3) a child cursor node of a recursive cursor node which will be defined with a relative XPath from the recursive cursor node. The mapping 400 of the shredding tree 300 in FIG. 4 includes cursor nodes of only two of these three kinds. Thus, the cursor node 410 is a recursive cursor node of type (2) because it is specified by a recursive XPath, and the cursor node 430 has type (3) because it is the child of a recursive cursor node and it is specified by a relative XPath. A data node is specified as the relative XPath to its parent cursor node. The relative XPath preferably does not contain any part as recursive. The number of recursive cursors for a given recursive shredding tree 300, in most cases, is 0 (not recursive) or 1 (having one recursive cursor node).

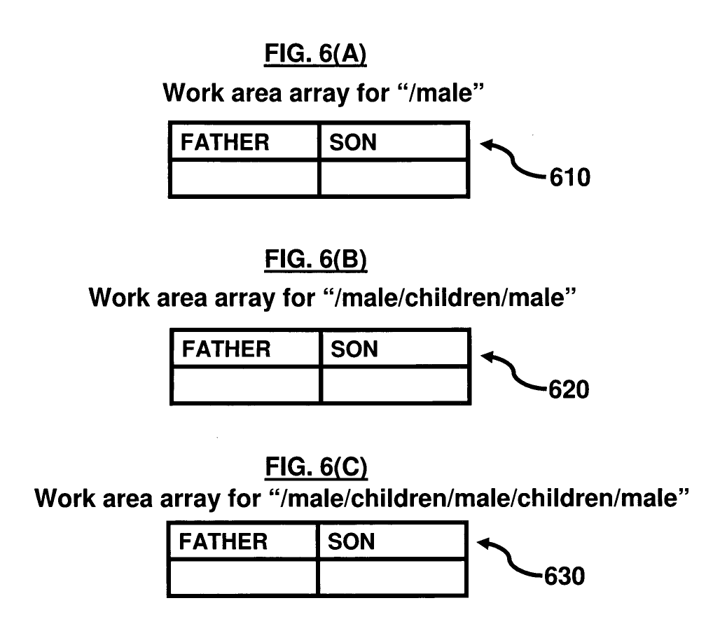

A work area is a set of arrays comprising the non-completed records (or tuples) of the shredding data of a shredding tree 300. The work area arrays 610, 620, 630 corresponding to the shredding tree 300 are depicted in FIGS. 6(A) through 6(C). For a non-recursive shredding tree, there is one-to-one mapping from a shredding tree to the working area. For a recursive shredding tree 300, there is one-to-many mapping from the shredding tree 300 to the working areas. The arrays 610, 620, 630 in the working area are used as temporary storage for the records obtained during the shredding process. Thus, each such array 610, 620, 630 is dedicated to storing the records obtained from shredding elements at the same recursive level in the XML tree 300. For example, the first array 610 will store records corresponding to “male” elements at recursive level 0, that is (“Adrian”, “Bill”), (“Adrian”, “Tom”), and (“Adrian”, “George”). A working area identifier is an identifier of the working area for a shredding tree. For a recursive shredding tree 300 with a recursive degree of one, the identifier is the absolute XPath matching the recursive XPath. For example, the identifiers for the father-son relationship are /male/children/male, male/children/male/children/male . . . . For a recursive tree 300 with recursive level higher than 1, the identifier is defined as the tuple of the absolute XPaths as (X1, X2, . . . , Xn). The number of the XPaths in the tuple is the same as the recursive level (for example, n). Furthermore, one of the features of the tuple is these XPaths are totally ordered, and any XPath has all of its previous XPath as part of its string (XPath is represented as string). This is a direct consequence of the total order property of the cursor nodes 410, 430.

A realized shredding tree is a shredding tree without any recursive cursor node, and is created from the recursive shredding tree 300 by replacing the recursive cursor node XPaths with the absolute path. In this context, an absolute path is a path that starts from the root node 301 and includes only “/” symbols (no “1”). This replacement occurs as follows: the first time a new recursive level is encountered in the XML document 200, a new realized tree 300 corresponding to that recursive level is created by replacing the recursive XPath expression with the current absolute path and any relative XPath expressions with the appropriate absolute XPath (computed by replacing the “.” symbol with the current path. The realized shredding tree 300 has the same identifier as the working area identifier, which enables the matching of a realized shredding tree 300 with its corresponding work area array 610, 620, or 630. There is one-to-many relationship from recursive shredding tree to realized shredding trees. This is in contrast to a non-recursive shredding process, where the original shredding tree is used directly, without the need to create realized shredding trees at system run-time.

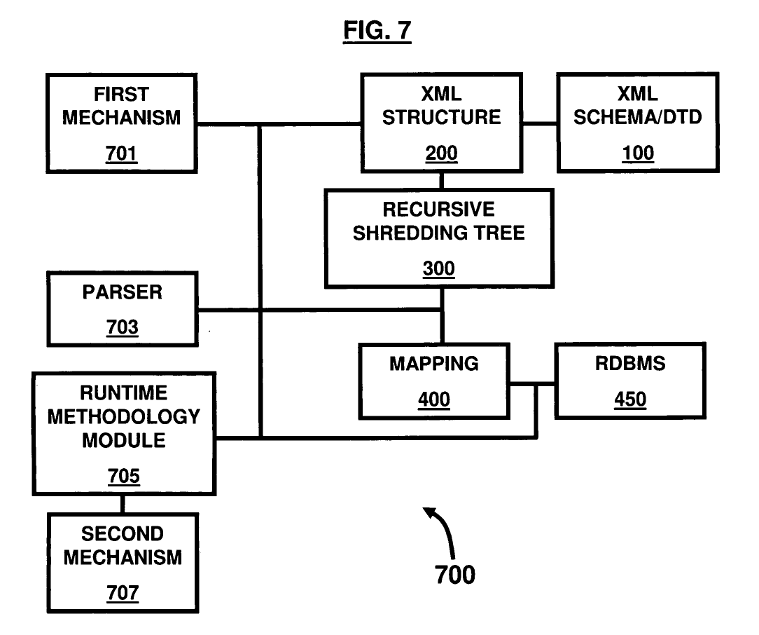

A temporary table is defined based on the number of parameters of the structured query language (SQL) command specified by the action node and the data type of the parameters. The temporary table is a staging area in main memory (not shown) of the system (for example system 700 shown in FIG. 7) and it is used for the temporary storage of the completed records obtained in the shredding process. The temporary table holds the shredding values from the XML document 200 in the run time of transformation. The data of the temporary table is used to execute SQL commands when it is emptied by a partial commit action. The partial commit action occurs after a user-specified number of tuples have been collected in the temporary table. The columns of the temporary table are fully ordered based on the location of the corresponding parameter in the SQL command. This facilitates the parameter instantiation at the time the SQL command is submitted to the RDBMS 450.

The finished records or tuples in the working areas are moved into the temporary table, and wait to be processed by the runtime module (not shown) to update the RDBMS 450 based on the parameterized SQL specified for the temporary table. There is a one-to-one mapping from the temporary table to the recursive shredding tree 300, which facilitates the management of the temporary table because there is a single shredding process that inserts records in a given temporary table.

In a detect recursive implementation, given a XML schema or DTD document 100, one can check if it is recursive by building a directed graph with element names as nodes and arcs from every element node A to every element node B that can appear as a child of A: the schema is recursive if and only if this graph contains cycles. This property enables a DTD parser 703 (of FIG. 7) to recognize a recursive schema at compile time and invoke the appropriate runtime recursive shredding process as opposed to the runtime for non-recursive shredding. In a script mapping implementation, the script parser 703 (of FIG. 7) parses the mapping script to accomplish the following tasks: (1) create all of the shredding tree(s) 300; (2) for each shredding tree 300, identify the recursive cursor nodes 410, 430 and the recursive cursor node type, as described above.

In a preferred embodiment, data structure implementation, each recursive shredding tree has (1) a hashtable, named as working area hashtable, whereby the key of the hashtable is the identifier of the working area; and (2) a global lookup table used to map the cursor XPath to the shredding tree nodes.

The embodiments also provide a system 700 for performing a recursive shredding process as is illustrated in FIG. 7, wherein the system 700 comprises a first mechanism 701 adapted to detect if an XML structure (for example, the XML structure 200 of FIG. 2) (for example, defined by the XML schema or DTD 100 shown in FIG. 1) is recursive; a recursive shredding tree (for example, the recursive shredding tree 300 of FIG. 3) adapted to represent the mapping 400 from a recursive XPath to columns of tables of a RDBMS 450; (3) a parser 703 adapted to parse the external script specifying the mapping 400 to the shredding trees 300; and (4) a runtime methodology module 705 adapted to shred the recursive XML document into the RDBMS 450, which includes a second mechanism 707 to invoke multiple non-recursive shredding processes based on the contents of the instance of shredded XML document.

With respect to the runtime methodology module 705 provided by the embodiments herein, the shredding process is defined as a process of retrieving portions of an XML document 200 into one or more relational database(s) 450. The process is specified by a set of recursive shredding trees 300. A shredding tree 300 is defined for all the shredding from the XML document 200 to a specific temporary table. A runtime engine (not shown) performs a depth-first tree traversal of the instance tree. During this process, each node of the XML tree 300 is visited. For each node (element, attribute, or text node) of the XML instance 200, the runtime engine computes the current XPath, and compares this XPath to the each of the XPaths stored in the global lookup table (not shown). For all of the matched XPaths, one will find all of the corresponding working areas for this absolute XPath. If any working area does not exist for this absolute XPath, one may create a new working area and have its identifier stored in the working area hashtable. This enables the efficient lookup of the relevant working area array 610, 620, or 630 in the future (when subsequent elements at the same recursive level are encountered).

The embodiments herein can take the form of an entirely hardware embodiment, an entirely software embodiment or an embodiment including both hardware and software elements. A preferred embodiment is implemented in software, which includes but is not limited to firmware, resident software, microcode, etc.

Furthermore, the embodiments herein can take the form of a computer program product accessible from a computer-usable or computer-readable medium providing program code for use by or in connection with a computer or any instruction execution system. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

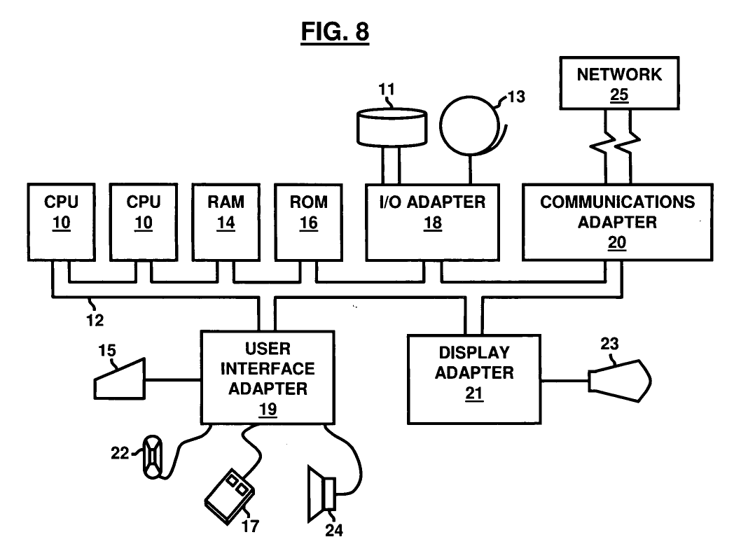

A representative hardware environment for practicing the embodiments herein is depicted in FIG. 8. This schematic drawing illustrates a hardware configuration of an information handling/computer system in accordance with the embodiments herein. The system comprises at least one processor or central processing unit (CPU) 10. The CPUs 10 are interconnected via system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of the embodiments herein. The system further includes a user interface adapter 19 that connects a keyboard 15, mouse 17, speaker 24, microphone 22, and/or other user interface devices such as a touch screen device (not shown) to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

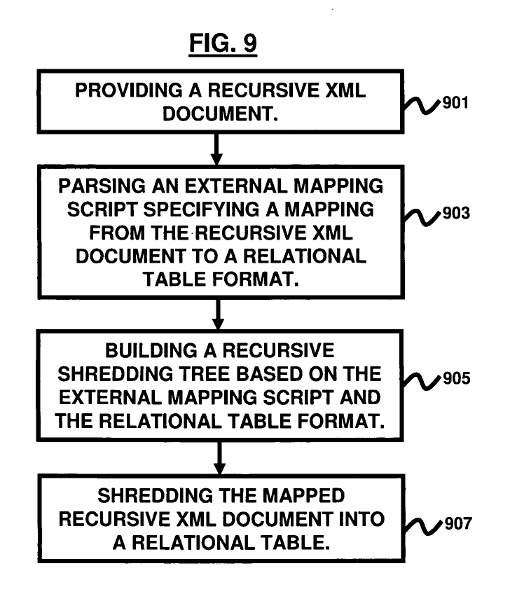

FIG. 9, with reference to FIGS. 1 through 8, is a flow diagram illustrating a method of converting a recursive XML document 200 into a relational schema, wherein the method comprises providing (901) a recursive XML document 200; parsing (903) an external mapping script specifying a mapping 400 from the recursive XML document 200 to a relational table format; building (905) a recursive shredding tree 300 based on the external mapping script and the relational table format; and shredding (907) the mapped recursive XML document 200 into a relational table 450. The method may further comprise detecting whether any of a XML schema and a DTD document 100 is recursive, wherein the detecting comprises building a directed graph comprising element names; corresponding elements names as nodes in the directed graph; forming arcs from every element parent node to every element child node of the element parent node; and checking for cycles in the directed graph.

The method may further comprise identifying all recursive cursor nodes 410, 430 and a recursive degree corresponding to the recursive shredding tree 300. Additionally, the method may further comprise mapping recursive elements of the recursive XML document 200 to shredding tree nodes of the recursive shredding tree 300. Preferably, the recursive shredding tree 300 comprises a working area hashtable. Moreover, the method may further comprise storing all XPaths of the recursive shredding tree 300 in a global lookup table; performing a depth-first tree traversal of the recursive shredding tree 300; computing a current XPath for each node in the recursive XML document 200; comparing the XPath to each of the stored XPaths in the global lookup table; and determining, for all matched XPaths, a corresponding set of arrays 610, 620, 630 comprising tuples of shredded data in the recursive shredding tree 300.

The foregoing description of the specific embodiments will so fully reveal the general nature herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. A method of converting a recursive eXtensible Markup Language (XML) document into a relational schema, said method comprising:
providing a recursive XML document;
parsing an external mapping script specifying a mapping from said recursive XML document to a relational table format;
building a recursive shredding tree based on said external mapping script and said relational table format; and
shredding the mapped recursive XML document into a relational table.

2. The method of claim 1, all the limitations of which are incorporated herein by reference, further comprising detecting whether any of a XML schema and a Document Type Definition (DTD) document is recursive, wherein the detecting comprises:
building a directed graph comprising element names;
corresponding elements names as nodes in said directed graph;
forming arcs from every element parent node to every element child node of said element parent node; and
checking for cycles in said directed graph.

3. The method of claim 1, all the limitations of which are incorporated herein by reference, further comprising identifying all recursive cursor nodes and a recursive degree corresponding to said recursive shredding tree.

4. The method of claim 1, all the limitations of which are incorporated herein by reference, further comprising mapping recursive elements of said recursive XML document to shredding tree nodes of said recursive shredding tree.

5. The method of claim 1, all the limitations of which are incorporated herein by reference, wherein said recursive shredding tree comprises a working area hashtable.

6. The method of claim 5, all the limitations of which are incorporated herein by reference, further comprising:
storing all XPaths of said recursive shredding tree in a global lookup table;
performing a depth-first tree traversal of said recursive shredding tree;
computing a current XPath for each node in said recursive XML document;
comparing said XPath to each of the stored XPaths in said global lookup table; and
determining, for all matched XPaths, a corresponding set of arrays comprising tuples of shredded data in said recursive shredding tree.

7. A program storage device readable by computer, tangibly embodying a program of instructions executable by said computer to perform a method of converting a recursive eXtensible Markup Language (XML) document into a relational schema, said method comprising:
providing a recursive XML document;
parsing an external mapping script specifying a mapping from said recursive XML document to a relational table format;
building a recursive shredding tree based on said external mapping script and said relational table format; and
shredding the mapped recursive XML document into a relational table.

8. The program storage device of claim 7, all the limitations of which are incorporated herein by reference, wherein said method further comprises detecting whether any of a XML schema and a Document Type Definition (DTD) document is recursive, wherein the detecting comprises:
building a directed graph comprising element names;
corresponding elements names as nodes in said directed graph;
forming arcs from every element parent node to every element child node of said element parent node; and
checking for cycles in said directed graph.

9. The program storage device of claim 7, all the limitations of which are incorporated herein by reference, wherein said method further comprises identifying all recursive cursor nodes and a recursive degree corresponding to said recursive shredding tree.

10. The program storage device of claim 7, all the limitations of which are incorporated herein by reference, wherein said method further comprises mapping recursive elements of said recursive XML document to shredding tree nodes of said recursive shredding tree.

11. The program storage device of claim 7, all the limitations of which are incorporated herein by reference, wherein said recursive shredding tree comprises a working area hashtable.

12. The program storage device of claim 11, all the limitations of which are incorporated herein by reference, wherein said method further comprises:
storing all XPaths of said recursive shredding tree in a global lookup table;
performing a depth-first tree traversal of said recursive shredding tree;
computing a current XPath for each node in said recursive XML document;
comparing said XPath to each of the stored XPaths in said global lookup table; and
determining, for all matched XPaths, a corresponding set of arrays comprising tuples of shredded data in said recursive shredding tree.

13. A system of converting a recursive eXtensible Markup Language (XML) document into a relational schema, said system comprising:
a recursive XML document;
a parser adapted to parse an external mapping script specifying a mapping from said recursive XML document to a relational table format;
a recursive shredding tree formatted based on said external mapping script and said relational table format; and
a relational table comprising the mapped recursive XML document.

14. The system of claim 13, all the limitations of which are incorporated herein by reference, further comprising a first mechanism adapted to detect whether any of a XML schema and a Document Type Definition (DTD) document is recursive by building a directed graph comprising element names; corresponding elements names as nodes in said directed graph; forming arcs from every element parent node to every element child node of said element parent node; and checking for cycles in said directed graph.

15. The system of claim 13, all the limitations of which are incorporated herein by reference, wherein said parser is adapted to identify all recursive cursor nodes and a recursive degree corresponding to said recursive shredding tree.

16. The system of claim 31, all the limitations of which are incorporated herein by reference, further comprising a mapping mechanism adapted to map recursive elements of said recursive XML document to shredding tree nodes of said recursive shredding tree.

17. The system of claim 16, all the limitations of which are incorporated herein by reference, wherein said mapping mechanism comprises a global lookup table.

18. The system of claim 13, all the limitations of which are incorporated herein by reference, wherein said recursive shredding tree comprises a working area hashtable.

19. The system of claim 17, all the limitations of which are incorporated herein by reference, further comprising a runtime methodology module adapted to:
store all XPaths of said recursive shredding tree in a global lookup table;
perform a depth-first tree traversal of said recursive shredding tree;
compute a current XPath for each node in said recursive XML document;
compare said XPath to each of the stored XPaths in said global lookup table; and
determine, for all matched XPaths, a corresponding set of arrays comprising tuples of shredded data in said recursive shredding tree.

20. The system of claim 14, all the limitations of which are incorporated herein by reference, further comprising a second mechanism adapted to invoke multiple non-recursive shredding processes based on a content of the mapped recursive XML document.
